(19) United States
(12) Patent Application Publication
(10) Pub. No.: US 2002/0181860 A1
(43) Pub. Date: Dec. 5, 2002

(54) Chromatic dispersion control method and apparatus

(76) Inventors: Laura A. Weller-Brophy, Corning, NY (US); Victor M. Schneider, Painted Post, NY (US); Daniel A. Nolan, Corning, NY (US)

Correspondence Address: Volentine Francos, P.L.L.C., Suite 150, 12200 Sunrise Valley Drive, Reston, VA, 20191, US

(21) Appl. No.: 09/983,769

(22) Filed: Oct. 25, 2001

Related U.S. Application Data
(60) Provisional application No. 60/295,054, filed on May 31, 2001.

(51) Int. Cl. G02B 6/26; G02B 6/28

(52) U.S. Cl. 385/27; 385/24

(57) ABSTRACT

According to an exemplary embodiment of the present invention, an optical device includes a chromatic dispersion control module which is dynamically tuneable over a prescribed wavelength range, and which does not include a waveguide grating

According to another exemplary embodiment of the present invention, a method of controlling chromatic dispersion in an optical signal includes coupling at least one wavelength channel to a dispersion control module. The dispersion control module includes at least one coupled waveguide structure. The method further includes altering a refractive index profile in at least one of the coupled waveguide structures.

### CROSS-REFERENCE TO RELATED APPLICATIONS

The present invention is related to and claims priority under 35 U.S.C. §119(e) from U.S. Provisional Patent Application Serial 60/295,054, entitled “Dispersion Dynamic Control Via Thermal and/or Optical Variation of Supermode Propagation”, filed May 31, 2001. The present invention is also related to U.S. patent application Ser. No. (Atty. Docket No.: CRNG.020/SP01-142) entitled “Dynamic Chromatic Dispersion Control Using Coupled Optical Waveguides”, filed on even date herewith, and assigned to the assignee of the present invention. The disclosures of the above-captioned provisional application and utility patent application are specifically incorporated by reference herein and for all purposes.

### FIELD OF THE INVENTION

The present invention relates generally to optical communications, and particularly to a method and apparatus for dynamically controlling chromatic dispersion in optical communications systems.

### BACKGROUND OF THE INVENTION

Optical transmission systems, including optical fiber communication systems, have become an attractive alternative for carrying voice and data at high speeds. In optical transmission systems, waveform degradation due to chromatic dispersion in the optical transmission medium can be problematic, particularly as transmission speeds continue to increase.

Chromatic dispersion (CD) results from the fact that in transmission media such as glass optical waveguides, the higher the frequency of the optical signal, the greater the refractive index. As such, higher frequency components of optical signals will “slow down,” and contrastingly, lower frequency signals will “speed-up.” In single mode optical fiber, chromatic dispersion results from the interplay of two underlying effects, material dispersion and waveguide dispersion. Material dispersion results from the nonlinear dependence upon wavelength of the refractive index, and the corresponding group velocity of the material, which is illustratively doped silica. Waveguide dispersion results from the wavelength dependent relationships of the group velocity to the core diameter and the difference in the index of refraction between the core and the cladding. Moreover, impurities in the waveguide material, mechanical stress and strain, and temperature effects can also affect the index of refraction, further adding to the ill-effects of chromatic dispersion.

In digital optical communications, where the optical signal is ideally a square wave, bit-spreading due to chromatic dispersion can be particularly problematic. To this end, as the “fast frequencies” slow down and the “slow frequencies” in the signal speed up as a result of chromatic dispersion, the shape of the waveform can be substantially impacted. The effects of this type of dispersion are a spreading of the original pulse in time, causing it to overflow in the time slot that has already been allotted to another bit. When the overflow becomes excessive, intersymbol interference (ISI) may result. ISI may result in an increase in the bit-error rate to unacceptable levels.

As can be appreciated, control of the total chromatic dispersion of transmission paths in an optical communication system is important, particularly in long-haul, and high-speed applications. In particular, it is necessary to reduce the total dispersion to a point where its contribution to the bit-error rate of the signal is acceptable. In commonly used dense wavelength division multiplexed (DWDM) optical communications systems, there may be 40 wavelength channels or more, having channel center wavelength spaced approximately 0.8 nm to approximately 1.0 nm apart. Illustratively, a 40-channel system could have center wavelengths in the range of approximately 1530 nm to approximately 1570 nm. As can be appreciated, compensating for chromatic dispersion in such a system, and in a dynamic manner, can be difficult.

One technique to dynamically compensate for chromatic dispersion includes the use of gratings such as chirped fiber Bragg gratings (FBG). A chirped fiber grating is a grating which has an increase in the period of the variation of the index of refraction as a function of distance along the fiber. The chirped fiber Bragg gratings are made by exposing specially doped fiber to an interference pattern of intense ultraviolet wavelength.

While compensation for chromatic dispersion through the use of chirped fiber Bragg gratings and other types of gratings have shown promise, these systems tend to be relatively complex and costly.

Accordingly, what is needed is a technique to control chromatic dispersion for use in optical fiber communications systems, which overcomes at least the drawbacks referenced in detail above.

### SUMMARY OF THE INVENTION

According to an exemplary embodiment of the present invention, an optical device includes a chromatic dispersion control module which is dynamically tuneable over a prescribed wavelength range, and which does not include a waveguide grating.

According to another exemplary embodiment of the present invention, a method of controlling chromatic dispersion in an optical signal includes coupling at least one wavelength channel to a dispersion control module. The dispersion control module includes at least one coupled waveguide structure. The method further includes altering a refractive index profile in at least one of the coupled waveguide structures.

### BRIEF DESCRIPTION OF THE DRAWINGS

The invention is best understood from the following detailed description when read with the accompanying drawing figures. It is emphasized that the various features are not necessarily drawn to scale. In fact, the dimensions may be arbitrarily increased or decreased for clarity of discussion.

FIG. 1 is a schematic block diagram of an optical communications system including dispersion control modules in accordance with an exemplary embodiment of the present invention.

FIG. 2(a) is graphical representation of the dispersion versus wavelength of three optical waveguides in accordance with an exemplary embodiment of the present invention.

FIG. 2(b) is graphical representation of the dispersion versus wavelength of three optical waveguides in accordance with an exemplary embodiment of the present invention.

FIGS. 3(a)-3(c) show the dispersion input versus wavelength for various optical waveguides in accordance with an exemplary embodiment of the present invention.

### DETAILED DESCRIPTION

In the following detailed description, for purposes of explanation and not limitation, exemplary embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known devices, methods and materials may be omitted so as to not obscure the description of the present invention.

Briefly, in accordance with an exemplary embodiment of the present invention, a method and apparatus for tuneably and dynamically controlling chromatic dispersion and/or dispersion slope in an optical signal is disclosed. In accordance with one exemplary embodiment of the present invention, each individual demultiplexed wavelength channel is input to a respective dispersion control module. Each dispersion control module includes at least one coupled waveguide structure which selectively and tuneably introduces chromatic dispersion and/or dispersion slope to the optical signal. Advantageously, positive and negative chromatic dispersion and/or dispersion slope can be introduced into the optical signal using a relatively simple construct of one or more coupled waveguide structures.

The chromatic dispersion and dispersion slope introduced to the optical signal are dynamically tuneable and may be variable at a particular wavelength or wavelengths. It is noted that variation of magnitude of the slope or chromatic dispersion is generally referred to as the variability of the chromatic dispersion adjustment or dispersion slope adjustment at a particular center wavelength. Moreover, each of the dispersion control modules in accordance with exemplary embodiments of the present invention may be adapted to operate over one or more wavelength channels, depending on tolerance requirements and signal conditions.

As will become more clear as the description of the present invention proceeds, the chromatic dispersion control module provides a great deal of versatility. For example, the chromatic dispersion control module according to an exemplary embodiment may substantially eliminate CD in the optical signal. To this end, the chromatic dispersion present in the optical signal at the input of the CD control module will be nullified at the output by introducing an equal but opposite amount of CD to the signal. Likewise, any dispersion slope may be nullified by the chromatic dispersion control module.

Alternatively, in accordance with an exemplary embodiment of the present invention it may be useful to introduce corrective, conditioning or altering chromatic dispersion and/or dispersion slope to an optical signal to bring these parameters to some required (non-zero) level. For example, this may be desirable at amplifier locations, and/or at a wavelength add-drop module (WADM) where it may not be desired to nullify chromatic dispersion and/or dispersion slope present in an optical signal. Instead, it may be desirable to have a net positive or negative chromatic dispersion value or dispersion slope value in an optical signal.

In addition, it may be desirable to use the CD control module in accordance with an exemplary embodiment of the present invention to effect dispersion equalization, wherein the chromatic dispersion of all channels is adjusted to some desired smoothly varying function. This is analogous to a gain-equalizer at an add/drop module where it is desired to have the optical power in all channels brought to some predetermined level. Equally, it may be advantageous to take all wavelength channels and set them to some optical CD profile.

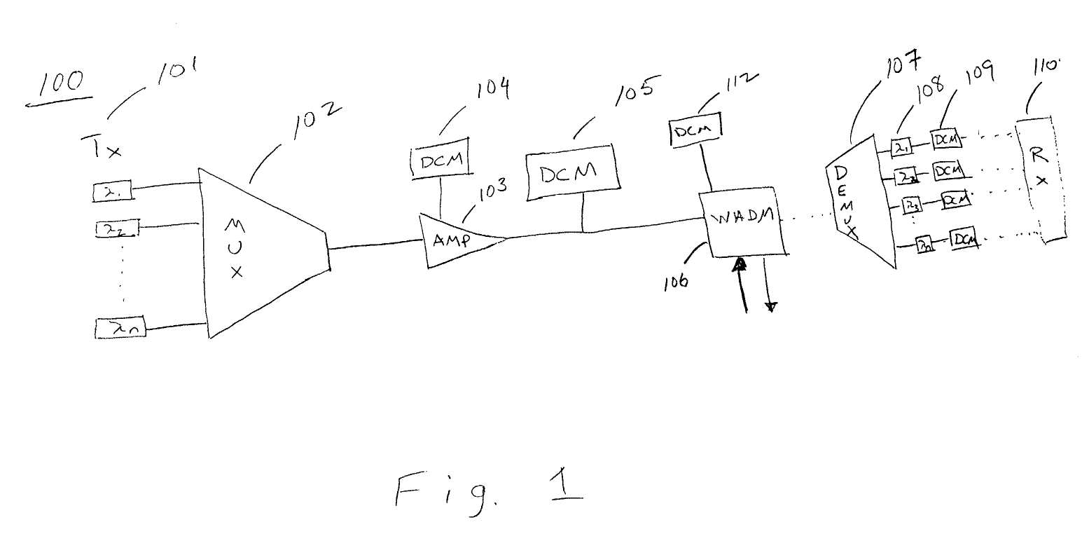

Turning to FIG. 1, an optical device 100 in accordance with an exemplary embodiment of the present invention is shown. A multiplexer 102 optical multiplexes a plurality of individual wavelength channels 101 at a transmit section. The multiplexed optical signal is input to an optical amplifier 103, which is illustratively an erbium doped fiber amplifier, well known to one having ordinary skill in the art. A first dispersion control module (DCM)104 may be included in the amplifier stage. The amplified signal is output from the amplifier, and a second dispersion control module 105 selectively introduces chromatic dispersion and/or dispersion slope to the output signal from the amplifier 103.

The optical transmission system may include a wavelength add/drop module 106. Such a module is useful in adding or dropping optical channels to or from an optical signal. A third dispersion control module 112 can be connected to the WADM 106 so as to selectively condition the chromatic dispersion as the wavelength channels are added onto the primary optical route. As referenced above, this conditioning is particularly advantageous in WADM applications.

Ultimately, the multiplexed optical signal is incident upon a demultiplexer 107. The output from the demultiplexer 107 is a plurality of individual wavelength channels 108. The n-individual wavelength channels have respective center wavelengths λ₁, λ₂, λ₃, . . . , λₙ, and the bandwidth of each individual wavelength channel generally complies with a well-known telecommunications standard, such as the International Telecommunications Union (ITU) standard.

Each of the plurality of individual wavelength channels 108 may have an unacceptable degree of chromatic dispersion and/or dispersion slope. As is well-known to one of ordinary skill in the art, sources of this chromatic dispersion may be the optical devices and elements of the optical communication system; and/or ambient and environmental factors to include mechanical strains and stresses, and temperature.

The tolerances for chromatic dispersion and dispersion slope in optical systems become increasingly tighter as the transmission rates increase. For example, the tolerances for dispersion compensation in a 40 Gbit/sec optical communication system is approximately 16 times more stringent than that of a 10 Gbit/sec optical communication system (i.e. the multiplier of the data-rate to a power of two). Accordingly, it may be useful to add corrective chromatic dispersion and/or dispersion slope not only during the transmission of the optical signal (e.g. using first, second and third DCM's), but also after demultiplexing of the individual wavelength channels at the receiver end of an optical communication system.

The demultiplexed wavelength channels are each incident upon a respective one of the plurality of receiver dispersion control modules (r-DCM) 109 in the illustrative embodiment of FIG. 1. Of course, this is merely illustrative, and as is described more fully herein one or more individual wavelength channels may be input to an r-DCM. The receiver dispersion control modules in accordance with the exemplary embodiment of FIG. 1 enable selective chromatic dispersion adjustment in a tuneable manner and variable using substantially coupled optical waveguide structures. The tuneability and variability of the chromatic dispersion adjustment and dispersion slope adjustment is effected in the module by altering the index of refraction of the one or more optical fibers of the dispersion control module 109. Ultimately, the dispersion-corrected optical signals of the wavelength channels are input to a receiver 110.

As mentioned, the receiver dispersion control modules 109 usefully include at least one coupled optical waveguide structure (not shown). The chromatic dispersion exhibited by the coupled waveguide(s), which support supermodes at a resonance frequency, may be changed in magnitude sign and slope by altering the index of refraction of the waveguide. Further details of exemplary optical waveguide(s) used for chromatic dispersion adjustment and dispersion slope adjustment, as well as illustrative mechanisms to selectively alter the index of refraction profiles of the coupled waveguides may be found in U.S. patent application Ser. No. (Attorney Docket Number CRNG.020; SP01-142) entitled “Dynamic Chromatic Dispersion Control Using Coupled Optical Waveguides”. Accordingly, the receiver dispersion control modules 109 illustratively incorporate and exploit the optical waveguides and mechanisms of the above-referenced patent application.

It is also noted that the first, second and third dispersion control modules, 104,105 and 112, respectively, are usefully relatively wide band dispersion control modules. These dispersion control modules may also be based on the dispersion control methods and apparati of the above-captioned patent application. Alternatively, these dispersion control modules may be based on a dispersion control technique described in U.S. patent application Ser. No. (Atty. Docket Number: CRNG.022, SP01-0149) entitled “Chromatic Dispersion Using Index Variation,” assigned to the assignee of the present application and filed on even date herewith. The disclosure of this patent application is also specifically incorporated by reference herein and for all purposes.

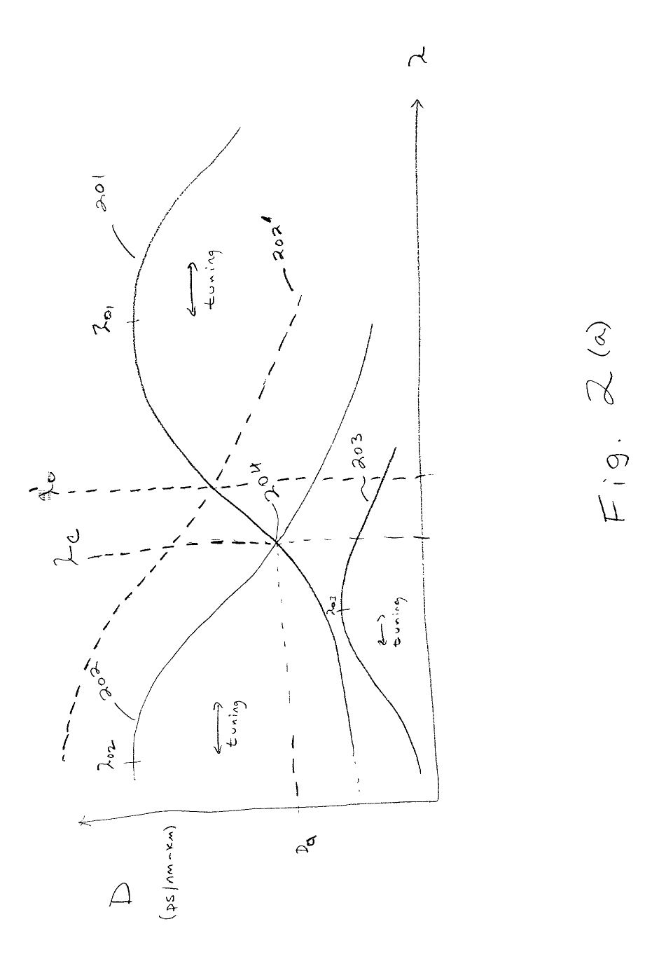

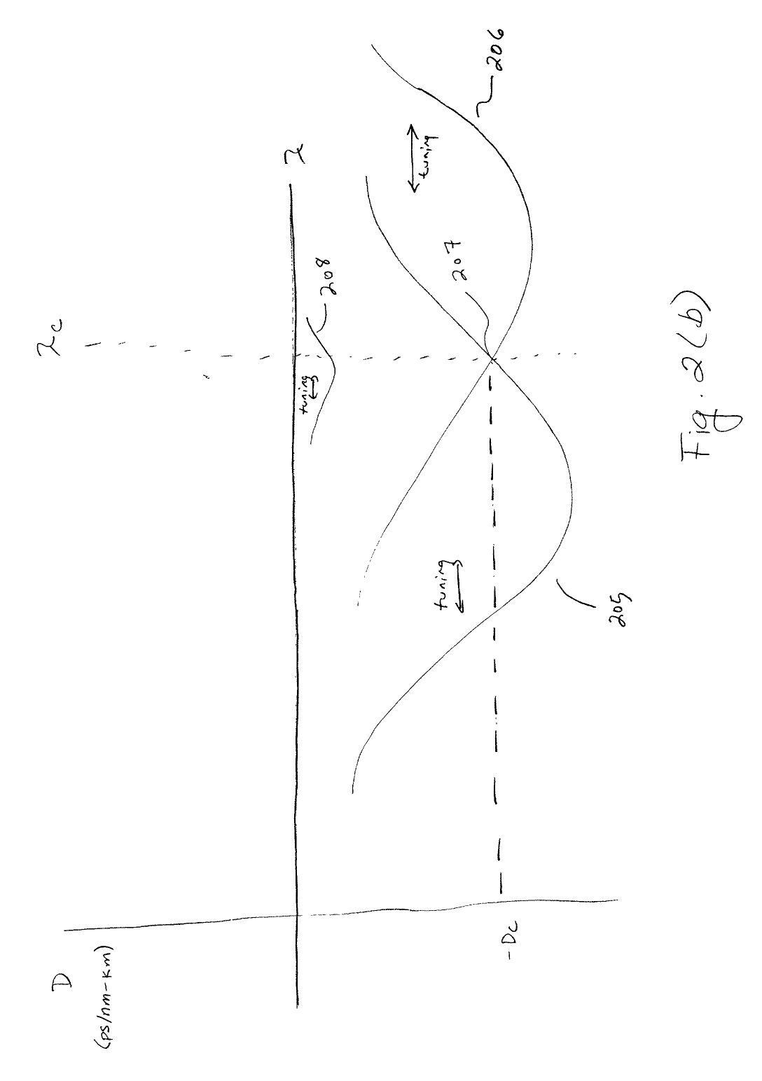

One such example of the use of the coupled optical waveguides of the above-captioned patent application is shown graphically in FIG. 2(a). FIG. 2(a) is a graph of the dispersion versus wavelength for a receiver dispersion control module 109 in accordance with an exemplary embodiment of the present invention. The receiver dispersion control module illustratively includes three waveguides. Each of these waveguides is a coupled waveguide structure as described in the above referenced patent application. A first waveguide has a first dispersion curve 201, and a second waveguide has second dispersion curve 202. A third waveguide which has a third dispersion curve 203, is particularly useful in controlling the slope of the dispersion.

In the exemplary embodiment shown in FIG. 2(a), the dispersion curves are those of the first harmonic supermodes (also referred to as the symmetric supermode or LP02) of the coupled waveguides. The first harmonic supersmodes are usefully excited using a mode converter (not shown). In the present illustrative embodiment, the chromatic dispersion added by the r-DCM is positive. Accordingly, the dispersion adjustment provided by this module is positive. As described herein, negative dispersion adjustment may be achieved by exciting the fundamental supermodes (also referred to as the asymmetric supermodes or LP01).

The first dispersion curve 201 is for a supported optical mode of a first optical waveguide having a resonance wavelength of ω₀₁, which corresponds to a resonant wavelength of λ₀₁. Likewise, the second dispersion curve 202 of the second waveguide has a resonant wavelength of λ₀₂, and the third dispersion curve 203 have a third resonant wavelength λ₀₃. At the junction of the first and second curves 204, a particular amount of chromatic dispersion may be introduced by the receiver dispersion control module. This junction 204 is chosen to be at a particular wavelength λ_{c}, which corresponds to the center wavelength of the particular wavelength channel which traverses this particular dispersion control module. In addition to introducing a particular amount of chromatic dispersion adjustment, Dₐ, the slope of the chromatic dispersion adjustment may also be controlled by the third waveguide having dispersion curve 203.

As can be appreciated, the chromatic dispersion introduced in the present exemplary embodiment is positive, while the slope of the dispersion is negative. Moreover, in the present exemplary embodiment the chromatic dispersion and dispersion slope of the optical signal input to the receiver dispersion control module are adjusted to zero by the introduction of corrective CD and dispersion slope having equal magnitude but opposite sign to that present in the optical signal. This is merely illustrative of the present invention, and as discussed above, according to an exemplary embodiment of the present invention the CD control modules may adjust the CD and dispersion slope to net positive or negative values.

By virtue of the ability to change the index of refraction of the particular coupled waveguides of the dispersion control modules of the exemplary embodiment, the resonant frequency/resonant wavelength of the individual waveguides may be changed. To wit, as is explained in the above-captioned patent application on dispersion compensation using coupled waveguides structures, the dispersion curves can be shifted. This enables “tuning” of each of the individual optical waveguides of the dispersion control module. This “tuning” is shown generally with arrows in the positive and negative directions along the wavelength axis in FIG. 2(a). Accordingly, the magnitude of the chromatic dispersion adjustment at the particular center wavelengths λ_{c} may be changed as needed through the change in the index of refraction. Moreover, shifting the third dispersion curve 203 can result in a change in the magnitude and sign of the dispersion slope adjustment. Additionally, shifting of the curves (e.g. shifting of curve 202 to curve 202′) can change the wavelength of the junction, and, accordingly enables introduction of chromatic dispersion and dispersion slope at another center wavelength λ′_{c}. Again, the magnitude of the chromatic dispersion adjustment and/or slope adjustment may be varied at this other center wavelength by altering the index of refraction (shifting of one or more of the dispersion curves).

Moreover, as is known, dispersion slope impairments can adversely impact signal transmission. Dispersion slope impairments may result from optical waveguide (e.g. fiber) dispersion slope; dispersion slope from optical components and equipment in the optical transmission system; and from thermal fluctuations, which can alter dispersion slope. The control and correction of dispersion slope becomes increasingly important for high transmission rate systems operating with certain transmission formats. For instance, 40 Gbps optical networks using RZ formats can be degraded when the received optical signal has 100 ps/nm² or more of chromatic dispersion slope.

Accordingly, one particularly advantageous aspect of the exemplary embodiments of the present invention is the ability to dynamically and tuneably control and adjust the dispersion slope. Illustratively, the slope adjustment at λ_{c} in FIG. 2(a) is negative. However, by “tuning” the third waveguide, the slope adjustment at λ_{c} may be changed in both magnitude and sign to achieve a desired result.

Finally, a few points are particularly noteworthy of the receiver dispersion control module in accordance with the exemplary embodiment described in connection with FIG. 2(a).

First, it is noted that the receiver dispersion control module illustratively adjusts the chromatic dispersion at a single wavelength channel having center wavelength λ_{c}. However, the receiver DCM could be designed to adjust chromatic dispersion and/or dispersion slope at more than one wavelength channel. Of course, this could be accomplished by selective tuning (e.g. shifting dispersion curve 202 to dispersion curve 202′ so the intersection of dispersion curve 202′ and dispersion curve 201 is at another center wavelength λ′_{c}). This may also be accomplished by having additional waveguides in the dispersion control module which have dispersion curves which are chosen to intersect at a particular center wavelength(s) of other waveguide channels, and at particular values of dispersion. Moreover, a particular dispersion slope could be added at these wavelength channel center wavelengths as needed.

Second, it is noted that the use of three waveguides to achieve dispersion adjustment and dispersion slope adjustment is merely illustrative. To this end, more or fewer waveguides may be included to introduce a particular amount of chromatic dispersion and/or dispersion slope to an optical signal. For example, as referenced above, it is possible to adjust the chromatic dispersion and dispersion slope by desired amounts at multiple wavelength channel center wavelengths using a plurality of waveguides having a variety of dispersion curves which are chosen to selectively intersect and desired wavelengths. Additionally, it may be possible to use fewer than three waveguides to adjust the dispersion and dispersion slope by desired amounts at a desired wavelength or wavelengths.

Third, it is noted that the dispersion curve 203, which adds dispersion slope to the optical signal also adds a certain magnitude of chromatic dispersion. This added chromatic dispersion must be accounted for in realizing the final level of dispersion adjustment, Dₐ.

The exemplary embodiment described in connection with FIG. 2(a) relates particularly to adjusting chromatic dispersion and dispersion slope through the introduction of positive chromatic dispersion and negative dispersion slope. It is again emhasized that the chromatic dispersion adjustment and the slope adjustment in accordance with exemplary embodiments of the present invention may be positive, negative or zero. An example of negative adjustment of the chromatic dispersion and positive adjustment of dispersion slope is described presently.

Consistent with the exemplary embodiment of FIG. 2(a), the exemplary embodiment described in connection with FIG. 2(b) is a receiver DCM which includes three waveguides. These waveguides are coupled waveguides as described in the above captioned application. It is noted however that the supermodes which exhibit negative chromatic dispersion characteristics as shown in FIG. 2(b) are orthogonal to the supermodes to the supermodes which exhibit an equal but opposite (positive) dispersion characteristics. To wit, the presently described supermodes are the fundamental modes of the coupled waveguides of the illustrative receiver DCM. These fundamental modes are the asymmetric (or LP01) supermodes of the coupled waveguides.

It is noted that simultaneous excitation of both the symmetric and asymmetric modes of a given waveguide or waveguides of a receiver DCM should be avoided. To this end, the dispersion curves of the fundamental and first harmonic modes are mirror images of one another, and if simultaneously excited would result in no chromatic dispersion adjustment by the receiver DCM. In practice, the optical mode input of the illustrative receiver DCM may be coupled to either the symmetric or asymmetric mode of the coupled waveguide using one or more optical couplers (mode couplers) to excite the specific mode required to effect the desired chromatic dispersion adjustment and/or dispersion slope adjustment

In the illustrative embodiment shown in FIG. 2(b), a first dispersion curve 205 of a first waveguide intersects a second dispersion curve 206 of a second waveguide at a point 207 which corresponds to center wavelength λ_{c} of a particular wavelength channel. This results in the adjustment of chromatic dispersion compensation by an amount (−)Dₐ. Moreover, a dispersion slope adjustment is introduced by a third waveguide of the module having a dispersion curve 203. Illustratively, the dispersion slope adjustment is positive. Of course this is merely illustrative, and this slope could be zero or negative as well.

As noted in connection with the exemplary embodiment of FIG. 2(a), the receiver DCM of the exemplary embodiment of FIG. 2(b) can be dynamically tuned to effect a selected amount of dispersion adjustment and/or slope adjustment at other center wavelengths by shifting the curves (again designated by “tuning” in the Figure). Likewise, the amount of chromatic dispersion adjustment and/or slope adjustment at the selected wavelength (λ_{c}) can be selectively varied.

It is emphasized that the salient points described in connection with the receiver DCM described in connection with FIG. 2(a) also apply to the present illustrative embodiment. As such, in the interest of brevity, these points are not repeated.

While the above description surrounding FIGS. 2(a) and 2(b) are used to illustrate an r-DCM 109, it is particularly emphasized that first, second, and third DCM's may also be based on identical techniques and methods. As such, first, second and third DCM's, 104, 105, and 112, respectively may be dynamically tuned to adjust the chromatic dispersion and dispersion slope present in an optical signal. Moreover, these DCM's may incorporate fewer or more coupled waveguides than the illustrative three-coupled waveguides.

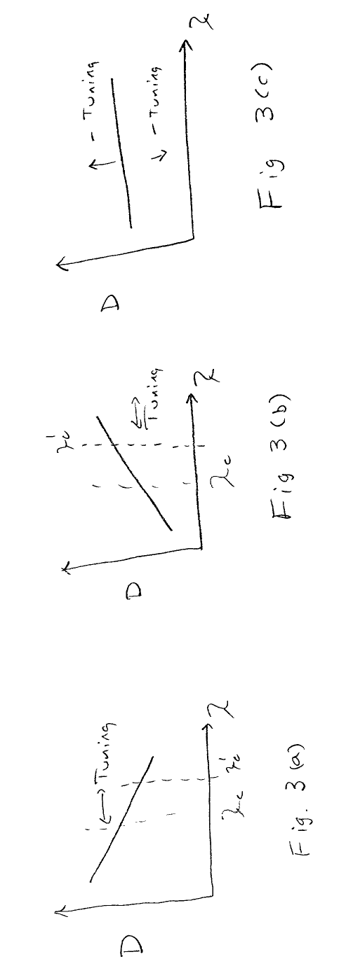

Turning to FIGS. 3(a)-3(c), representative dispersion curves versus wavelength in accordance with an exemplary embodiment of the present invention are shown to more simply describe the tuning ability of the dispersion control modules in accordance with an exemplary embodiment of the present invention. These graphical representations are illustratively portions of the dispersion curves shown in FIG. 2(a) and/or FIG. 2(b) close to the intersection point at the center wavelength λ_{c} of the particular wavelength channel to which corrective CD is being added.

As shown in FIGS. 3(a) and 3(b), the ability to tune the amount of chromatic dispersion introduced by the receiver DCM at a particular center wavelength is readily effected in accordance with the exemplary embodiments of the present invention by the alteration of the index of refraction profile of the coupled optical waveguides. The tuning, which is shown by arrows in the graphs in FIGS. 3(a) and 3(b), ultimately results in the ability to increase or decrease the magnitude of the dispersion at a particular center wavelength as is shown in FIG. 3(c). In the present illustrative embodiment, the dispersion adjustment is positive, and two optical fibers are used to alter the magnitude of the adjustment. Of course, this tuning capability could be used to change the point of intersection of curves resulting in chromatic dispersion adjustment at a different center wavelength than λ′_{c}, as described above. Moreover, as described above, the adjustment of the dispersion slope may be tuned as well.

As noted above, the dispersion control modules in accordance with an exemplary embodiment of the present invention can incorporate one or more optical fibers, and may be applied to a variety of scenarios in an optical communications system. As referenced above, the various standards bodies (e.g., the ITU) prescribe the tolerances for chromatic dispersion in a particular optical communication system. To illustrate the adaptability of the present invention to effect dynamic chromatic dispersion compensation within specified tolerances, three scenarios are described presently.

In a first example, in an add-drop multiplexer (for example wavelength add-drop multiplexer 106 of FIG. 1) it may in fact be necessary to tailor the individual dispersion control modules 109 for each wavelength channel. To wit, it may be necessary to have a different dispersion control module 109 for each wavelength channel. In this scenario, each dispersion control module, which is matched to a particular wavelength channel, would have relatively narrow bandwidth (i.e. slightly greater than the bandwidth of the wavelength channel). Over this bandwidth, the dispersion control module would tuneably effect the desired magnitude and slope of dispersion adjustment to an optical signal so that the output therefrom and input to the receiver (e.g. receiver 110) has a desired dispersion value and dispersion slope within prescribed tolerances. As described above, the output of the dispersion control modules in accordance with an exemplary embodiment of the present invention may have zero chromatic dispersion and zero dispersion slope, in which case the chromatic dispersion and slope have been nullified. Alternatively, the output may have positive or negative chromatic dispersion levels and positive or negative dispersion slope, as desired. Each of the dispersion control modules 109 of the present illustrative embodiment may include one or more optical waveguides described in the above referenced patent application drawn to coupled waveguide chromatic dispersion adjustment, and a device which alters the index of refraction in a controlled manner.

In another example, it may be possible that the dispersion control modules 109 could effectively adjust the chromatic dispersion over a plurality of channels. For example, according to an exemplary embodiment, four wavelength channels could be adequately adjusted to within dispersion tolerance by a particular module. At least one optical waveguide structure would be necessary and would include a device to effectively alter the index of refraction profile of the coupled optical waveguides.

According to yet another exemplary embodiment, it is possible to have a dispersion control module 109 which could effectively tune to any center channel wavelength across a particular band (e.g., all 40 channels of a particular DWDM optical communication system), and introduce a suitable amount of dispersion adjustment to optical signals of each individual wavelength channel to be within prescribed dispersion tolerances. Again, this may be carried out using a dispersion control module having one or more coupled waveguide structures as well as a device to alter the index of refraction profile for the coupled waveguide(s). A dispersion control module that can be used to adjust chromatic dispersion and/or dispersion slope of any optical channel is termed “colorless.” Such dispersion control modules are useful in optical networks where wavelength channels are tuneably routed. In such cases, it is not known a priori which wavelength channel will be received by which optical receiver.

In some cases, it may be sufficient to have a dispersion control module that can adjust the chromatic dispersion in one of a number of contiguous optical channels. Such a dispersion control module may be termed “banded”; the module may receive any one of a number of contiguous optical channels and be tuned to correct for the dispersion impairment of that channel. It is within the purview of the present invention as described in connection with the exemplary embodiments to have chromatic dispersion control modules that are banded or colorless.

The invention having been described in detail in connection through a discussion of exemplary embodiments, it is clear that modifications of the invention will be apparent to one having ordinary skill in the art having had the benefit of the present disclosure. Such modifications and variations are included in the scope of the appended claims.

We claim:

1. An optical device, comprising:
a chromatic dispersion control module which is dynamically tuneable over a prescribed wavelength range, and which does not include a waveguide grating.

2. An optical device as recited in claim 1, wherein said module further comprises at least one coupled waveguide structure.

3. An optical device as recited in claim 2, wherein said module further includes a device which controllably alters an index of refraction profile of each of said at least one coupled waveguide structures.

4. An optical device as recited in claim 3, wherein said altering of said index of refraction profile is dynamic.

5. An optical device as recited in claim 3, wherein said altering of said index of refraction profile effects said dynamic tuning of said module.

6. An optical device as recited in claim 1, wherein said module dynamically and tuneably adjusts dispersion slope.

7. An optical devices as recited in claim 1, wherein said module dynamically and tuneably adjusts both chromatic dispersion and dispersion slope.

8. An optical device as recited in claim 2, wherein said module includes three coupled waveguides and said module is adapted to variably adjust chromatic dispersion at a particular wavelength channel center wavelength.

9. An optical device as recited in claim 7, wherein said module is adapted to variably adjust dispersion slope at said center wavelength.

10. An optical device as recited in claim 3, wherein said device is chosen from the group consisting essentially of: a temperature controller, and an optical energy source.

11. An optical device as recited in claim 1, wherein said module is adapted to receive a wavelength channel having a center wavelength λ_{c}.

12. An optical device as recited in claim 1, wherein said module is adapted to receive a plurality of wavelength channels having respective center wavelengths over at least a portion of said wavelength range.

13. An optical device as recited in claim 12, wherein said module is adapted to a variably adjust chromatic dispersion at each of said center wavelengths.

14. An optical device as recited in claim 12, wherein said module is adapted to variably adjust dispersion slope at each of said center wavelengths.

15. An optical device as recited in claim 1, wherein said wavelength range is approximately 1530 nm to approximately 1570 nm.

16. An optical device as recited in claim 12, wherein said plurality of wavelength channels is in the range of approximately two channels to approximately 40 channels.

17. An optical device as recited in claim 1, wherein said chromatic dispersion control module is colorless.

18. An optical device as recited in claim 1, wherein at least two of said chromatic dispersion control modules are used together with one or more wavelength division multiplexers/demultiplexers.

19. An optical device as recited in claim 18, wherein said one or more wavelength division multiplexers/demultiplexers direct each of a plurality of wavelength channels to a respective one of the chromatic dispersion control modules.

20. An optical device as recited in claim 18, wherein one of said wavelength division multiplexers/demultiplexers direct bands of wavelength channels to one or more separate chromatic dispersion control modules.

21. An optical device as recited in claim 1, wherein said dispersion control module adjusts a chromatic dispersion present in an optical signal to zero.

22. An optical device as recited in claim 1, wherein said dispersion control module adjusts a dispersion slope present in an optical signal to zero.

23. An optical device as recited in claim 1, wherein said dispersion control module adjusts a chromatic dispersion present in an optical signal to a positive value.

24. An optical device as recited in claim 1, wherein said dispersion control module adjusts a chromatic dispersion present in an optical signal to a negative value.

25. An optical device as recited in claim 1, wherein said dispersion control module adjusts a dispersion slope present in an optical signal to a positive value.

26. An optical device as recited in claim 1, wherein said dispersion control module adjusts a dispersion slope present in an optical signal to a negative value.

27. A method of controlling chromatic dispersion in an optical signal, the method comprising:
coupling at least one wavelength channel into a dispersion control module, which includes at least one coupled waveguide structure; and
altering an index of refraction profile in at least one of said at least one coupled waveguide structures.

28. A method as recited in claim 27, wherein the method further comprises controlling a dispersion slope of the optical signal.

29. A method as recited in claim 27, wherein the controlling of the chromatic dispersion is dynamically tuneable over a prescribed wavelength range.

30. A method as recited in claim 27, wherein the method is dynamically tuneable at each of at least one center wavelengths.

31. A method as recited in claim 28, wherein said controlling of said dispersion slope is dynamically tuneable over a prescribed wavelength range.

32. A method as recited in claim 28, wherein said controlling of said dispersion slope is dynamically tuneable at each of said at least one center wavelengths.

33. A method as recited in claim 27, wherein said altering further comprises changing a temperature of said at least one coupled waveguide structure.

34. A method as recited in claim 27, wherein said altering further comprises introducing optical energy from a secondary optical source to said at least one coupled waveguide structure.

35. A method as recited in claim 29, wherein said prescribed wavelength range is approximately 1530 nm to approximately 1570 nm.

36. A method as recited in claim 31, wherein said prescribed wavelength range is approximately 1530 nm to approximately 1570 nm.

37. A method as recited in claim 27, wherein the controlling of the chromatic dispersion further comprises adjusting the chromatic dispersion by an amount in the range of approximately −1000 ps/nm to approximately +1000 ps/nm.

38. A method as recited in claim 28, wherein the controlling of said dispersion slope further comprising adjusting said dispersion slope by an amount in the range of approximately −400 ps/nm² to approximately +400 ps/nm².

39. A method as recited in claim 27, wherein one wavelength channel having a center wavelength is coupled to said module.

40. A method as recited in claim 27, wherein a plurality of wavelength channels each having a center wavelength is coupled to said module.

41. A method as recited in claim 40, wherein said plurality of wavelength channels is in the range of approximately 2 to approximately 40.

42. A method as recited in claim 27, wherein the chromatic dispersion present in the optical signal after the controlling of the chromatic dispersion is zero.

43. A method as recited in claim 28, wherein the dispersion slope present in the signal after the controlling of the dispersion slope is zero.

44. A method as recited in claim 27, wherein the chromatic dispersion present in the optical signal after the controlling of the chromatic dispersion is a positive value.

45. A method as recited in claim 28, wherein the dispersion slope present in the signal after the controlling of the dispersion slope is a positive value.

46. A method as recited in claim 27, wherein the chromatic dispersion present in the optical signal after the controlling of the chromatic dispersion is a negative value.

47. A method as recited in claim 28, wherein the dispersion slope present in the signal after the controlling of the dispersion slope is a negative value.
